(19) United States
(12) Patent Application Publication
(10) Pub. No.: US 2019/0197266 A1
(43) Pub. Date: Jun. 27, 2019

(54) RFID Tracking

(71) Applicant: Newport Digital Technologies Australia Pty Ltd, Victoria (AU)

(72) Inventors: Aniruddha Anil Desai, Victoria (AU); Kriyangbhai Vinodbhai Shah, Victoria (AU); David Fitrio, Victoria (AU); Muthuthanthreege Lasith Eranga Fernando, Victoria (AU); Jugdutt Singh, Victoria (AU)

(21) Appl. No.: 16/221,063

(22) Filed: Dec. 14, 2018

Related U.S. Application Data
(63) Continuation of application No. 14/819,783, filed on Aug. 6, 2015, now abandoned.
Application No. 14/819,783 is a continuation of application No. PCT/AU2014/000096, filed on Feb. 7, 2014.

(30) Foreign Application Priority Data
Feb. 7, 2013 (AU) 2013900384

(51) Int. Cl. G06K 7/10; G06K 19/07

(52) U.S. Cl. CPC G06K 7/10207; G06K 19/0723; G06K 19/0717; G06K 19/0715; G06K 19/0716; G06K 19/0709; G06K 19/0705

(57) ABSTRACT

A method of communicating with one or more RFID sensor tags within a predetermined area. The method comprises: providing an RFID sensor tag interrogation apparatus comprising an RF transceiver configured to enable control of a transmitted RF power level; setting the transmitted RF power level to provide an RF signal detectable by RFID sensor tags located within a corresponding region of the predetermined area; transmitting, by the RFID sensor tag interrogation apparatus, an RFID sensor tag interrogation signal; and receiving, by the RFID sensor tag interrogation apparatus, one or more responses transmitted by the RFID sensor tags located within the predetermined area. In some embodiments the transmitted RF power level is adjusted to increase or decrease the size of the corresponding region of the predetermined area, based upon responses received from RFID sensor tags located within the region.

### CROSS-REFERENCE TO RELATED APPLICATIONS

This application claims priority under 35 U.S.C. § 111(a) as a continuation of International Application No. PCT/AU2014/000096, “Improvements in RFID Tracking,” filed Feb. 7, 2014, with priority to Australian Application No. AU 2013900384, filed Feb. 7, 2013, each of which is incorporated by reference herein, in the entirety and for all purposes.

### FIELD

The present invention relates to the use of RFID tags for tracking and sensing of articles and equipment, and in particular to improvements in RFID sensor tags which are configured to detect, record and relay environmental information and the like, in addition to providing a basic identification function. Embodiments of the invention may be applied in a number of fields, including security, food safety, surveillance, logistics, transportation, agriculture, inventory management, asset tracking, and so forth.

### BACKGROUND

Radio Frequency Identification (RFID) is a widely-deployed technology having a range of applications in logistics, transportation, inventory management, asset tracking, and so forth.

Existing RFID deployments generally operate within the very-high-frequency (VHF) band, between 30 and 300 MHz. and/or in the ultra-high-frequency (UHF) band, between 300 MHz and 3 GHz. A common operating frequency, for example, is within the 2.4 GHz unlicensed band.

A majority of RFID deployments are used solely, or primarily, for basic identification. The RFID tags used in such deployments are typically passive, i.e. have no power source of their own, and are activated and powered entirely from the energy of the RF fields used for interrogation of the tags. Typically, an RFID tag reader, which may be fixed or portable, is operated within the vicinity of tagged articles, equipment or the like, generating an interrogation signal which activates and queries the RFID tags to provide identification information and/or other fixed stored data. An RFID reader/writer device may be used to add or update information stored within an RFID tag.

Such RFID tracking systems may be used to monitor the progress of articles or equipment within a facility, or through a known process. Monitoring depends upon the tags coming into proximity with an RFID reader/writer device, at which time identity and other information may be retrieved from and/or stored within, the tag. However, no further information is available, or acquired, when the tag is not within the proximity of a suitable RFID reader.

There exist some applications in which continuous monitoring of location and/or environmental conditions may be desirable. For example, perishable goods, such as foodstuffs, may require storage and transport within a known safe temperature range. If, at any time, the ambient temperature falls outside this range, the quality and safety of the stored food may be compromised. During transportation in particular this could occur at any time, and not only when the tagged products are located in proximity to a suitable RFID reader and additional environmental monitoring and control equipment.

In other scenarios it may be desirable to provide continuous monitoring of other aspects of a tagged article, product or equipment, such as location, light exposure, moisture/humidity exposure, and other environmental factors. There is therefore a need for an improved RFID tag and system which is able to provide such continuous monitoring of environmental conditions and other factors. As a practical consideration, RFID tags should preferably have very low power consumption, and minimum storage requirements for recorded environmental information, so as to minimise cost and maximise operating life, both of which are important parameters in a viable commercial deployment.

Furthermore, with the VHF and UHF bands increasingly crowded with a variety of communications applications, it may be desirable to provide an RFID tagging and sensing system which operates within an alternative frequency band, for example the Super-High-Frequency (SHF) band between 3 and 30 GHz. In particular, the frequency band between 5.725 and 5.850 GHz is an unlicensed band in Australia, and a number of other jurisdictions.

In various aspects and embodiments the present invention seeks to address these desirable features.

### SUMMARY

In one aspect, the present invention provides a method of operating an RFID sensor tag which comprises an RF transceiver, a power source, and one or more sensors, the method comprising:
placing the RFID sensor tag in a low power-consumption state;
upon satisfaction of a predetermined condition, placing the RFID sensor tag in a medium power-consumption state for performing sensor measurements via the one or more sensors;
upon detecting an RF signal via the RF transceiver, placing the RFID sensor tag in a high power-consumption state for engaging in RF communication with an RF signal source; and
upon completion of RF communication or sensor measurements, returning the RFID sensor tag to the low power-consumption state.

Advantageously, embodiments of the inventive method result in reduced overall power consumption by operation of the RFID sensor tag, thereby extending the effective life of the power source, e.g. an on-board battery.

Additionally, embodiments of the invention employ an RFID sensor tag which is configured to harvest RF energy from received RF signals, so as to further reduce the drain on the power source.

### EXAMPLES

According to embodiments of the invention, the RF transceiver comprises receive/transmit circuitry, including at least one antenna, which may be fully-passive (i.e. powered wholly by harvested RF energy), semi-passive (e.g. partly powered by harvested RF energy with battery-assisted backscattering), semi-active (e.g. passive receiver and battery-assisted transmitter) or fully active (i.e. battery assisted transmitter and receiver).

According to embodiments of the invention, the RFID sensor tag comprises clock generation circuitry configured to generate clocks having at least two different rates, wherein:
placing the RFID sensor tag in a medium power-consumption state comprises operating the RFID sensor tag at a first clock rate; and
placing the RFID sensor tag in a high power-consumption state comprises operating the RFID sensor tag at a second clock rate,
wherein the second clock rate is higher than the first clock rate.

Additionally, a clock signal may be generated having a very slow clock rate, for operation of components of the RFID sensor tag which do not perform rapid operations or processing, in order to minimise power consumption of such components. The very slow clock rate may comprise a frequency of less than 1 Hz up to 1 kHz. or more particularly less than 100 hertz, or even more particularly less than 10 Hz. In an embodiment a clock rate of 3.8 Hz is employed.

The first clock rate may be a slow clock, for example operating between 1 kHz and 10 MHz. or more particularly less than 2 MHz, and in an exemplary embodiment being a 1 MHz clock rate.

The second clock rate may be a fast clock, for example operating at a rate higher than 1 MHz, more particularly higher than 10 MHz, and in one embodiment at 22 MHz.

According to embodiments of the invention, performing sensor measurements in the medium power consumption state comprises:
reading at least one sensor value from the one or more sensors; and
storing the sensor value in a memory of the RFID sensor tag, along with information associated with the predetermined condition.

In some embodiments, the predetermined condition is the passage of a predetermined time period, and the information associated with the predetermined condition is a corresponding time stamp. The time stamp may be, for example, a time offset parameter.

According to exemplary embodiments, performing sensor measurements in the medium power-consumption state comprises:
reading at least one sensor value from the one or more sensors;
comparing the sensor value with a predetermined recording criterion; and
in the event that the predetermined recording criterion is satisfied, storing the sensor value in a memory of the RFID sensor tag.

For example, the predetermined recording criterion may be that the sensor value falls within at least one predetermined range of values.

In exemplary embodiments, the sensors may include a temperature sensor, and the predetermined range of values may be values less than a minimum safe/desired value, and/or values greater than a maximum safe/desired value. Advantageously, this approach enables the RFID sensor tag to record only ‘critical’ sensor information, avoiding the consumption of limited memory resources for recording sensor data which is not of practical interest.

According to exemplary embodiments, engaging in RF communications in the high power-consumption state comprises:
receiving the RF signal;
determining whether the received RF signal comprises an instruction in accordance with a predetermined communications protocol;
providing a corresponding response, in the event that the received RF signal comprises an instruction in accordance with the predetermined communications protocol; and
returning the RFID sensor tag to the low power-consumption state in the event that the received RF signal does not comprise an instruction in accordance with the predetermined communications protocol.

Advantageously, this approach reduces time spent in the high power-consumption state in the event that a received RF signal does not comprise a recognisable instruction. Such a condition may arise, for example, due to spurious RF interference at the operating frequency of the RFID sensor tag, and/or the presence of other, incompatible, RF transmissions within this frequency range.

In exemplary embodiments, the response comprises one or more of: an indication of availability of sensor data recorded in a memory of the RFID sensor tag, and/or a status indication of the RFID sensor tag. Advantageously, a response which initially indicates, for example, only whether or not sensor data is available avoids the need for extended transmission of data in the event that no new or useful information is available.

Also in exemplary embodiments, the response comprises an indication of the availability of power from the power source. That is, embodiments of the invention enable simultaneous interrogation of content of the RFID sensor tag, along with monitoring of remaining battery life.

The response may further comprise one or more records of sensor data recorded in a memory of the RFID sensor tag. In exemplary embodiments, an instruction to respond by transmitting records of sensor data may be provided to the RFID sensor tag only following transmission of an indication of the availability of such data.

According to exemplary embodiments, in the event that the received RF signal does not comprise an instruction in accordance with a predetermined communications protocol, the method further comprises:
at least partially disabling the RF transceiver, and
re-enabling the RF transceiver upon satisfaction of a re-enablement condition.

Advantageously, such embodiments prevent spurious activation of the RFID sensor tag in the presence of RF interference and/or unrecognised signal sources. Since such interference is generally present over a period of time, there is a risk that the RFID sensor tag will be repeatedly reactivated into the high power-consumption state by an ongoing RF event. By disabling the RF transceiver until a subsequent re-enablement condition is satisfied, further spurious reactivation can be avoided.

In some embodiments, the re-enablement condition is passage of a specified time period. The specified time period may increase on each consecutive occasion on which the received RF signal does not comprise an instruction in accordance with the predetermined communications protocol, for example up to a predetermined maximum period.

As will be appreciated, alternative and/or additional conditions under which the RF transceiver may be at least partially disabled in order to conserve power, and subsequently re-enabled, may be implemented.

In another aspect, the invention provides a method of reading sensor data recorded in a memory of an RFID sensor tag which comprises an RF transceiver, a power source and one or more sensors, the method comprising:
receiving, by the RFID sensor tag, an RF signal comprising an instruction in accordance with a predetermined communications protocol;
transmitting, by the RFID sensor tag, an RF signal comprising a response indicative of availability of recorded sensor data;
receiving. by the RFID sensor tag, an RF signal comprising an instruction to transmit recorded sensor data, in accordance with the predetermined communications protocol; and
transmitting, by the RFID sensor tag, an RF signal comprising sensor data recorded in the memory.

In exemplary embodiments, the method further comprises:
the RFID sensor tag switching from a lower power-consumption state to a higher power-consumption state upon receiving an RF signal; and
the RFID sensor tag switching from the higher power-consumption state to the lower power-consumption state upon completion of processing of the received RF signal.

Processing of the received RF signal in the higher power-consumption state may comprise decoding a message in the received RF signal, generating a response message, and/or transmitting a response message.

Furthermore, in exemplary embodiments the response indicative of the availability of recorded sensor data further comprises an indication of the availability of power from the power source.

In a further aspect, the invention provides a method of communicating with one or more RFID sensor tags within a predetermined area, the method comprising:
providing an RFID sensor tag interrogation apparatus comprising an RF transceiver configured to enable control of a transmitted RF power level;
setting the transmitted RF power level to provide an RF signal detectable by RFID sensor tags located within a corresponding region of the predetermined area;
transmitting, by the RFID sensor tag interrogation apparatus, an RFID sensor tag interrogation signal; and
receiving, by the RFID sensor tag interrogation apparatus, one or more responses transmitted by the RFID sensor tags located within the predetermined area.

Advantageously, the use of an RF transceiver having a configurable transmitted RF power level enables the region within which RFID sensor tags are interrogated to be controlled through selection of an appropriate transmitted RF power level. Attenuation of the transmitted interrogation signal with increasing distance from the interrogation apparatus causes the selected RF power level to determine an effective range of interrogation.

In some embodiments, the method further comprises adjusting the transmitted RF power level to increase or decrease the size of the corresponding region of the predetermined area, based upon responses received from the RFID sensor tags located within the region. For example, if no responses are received, or a small number of responses is received, it may be desirable to increase the RF power level in order to encompass a wider area, which may contain additional RFID sensor tags. Conversely, tags may be interrogated over a smaller area, thereby encompassing a smaller number of RFID sensor tags, by decreasing transmitted RF power.

According to exemplary embodiments, the RFID sensor tags located within the predetermined area may be configured to ignore further sensor tag interrogation signals, for at least a predetermined period, once a response has been transmitted to the RFID sensor tag interrogation apparatus.

Advantageously, for example, this enables RFID tags within a particular area to be interrogated in a number of ‘zones’, while providing an assurance that each individual RFID sensor tag will respond only once during the interrogation process. This will beneficially reduce tag/response collision.

In yet another aspect, the invention provides an RFID sensor tag comprising:
a processor;
a power source;
an RF transceiver operably associated with the processor,
one or more sensors accessible to the processor via a sensor interface; and
at least one memory device, operably associated with the processor,
wherein the memory device contains program instructions accessible to, and executable by, the processor to cause the RFID sensor tag to implement a method according to an aspect of the invention.

As will be appreciated from the foregoing summary of methods embodying the invention, the RFID sensor tag may comprise further components, such as a watchdog timer, timestamp timer, clock control circuitry, and so forth.

For example, in one aspect the program instructions cause the RFID sensor tag to implement a method comprising:
entering a low power-consumption state;
upon satisfaction of a predetermined condition, entering a medium power-consumption state for performing sensor measurements via the one or more sensors;
upon detecting an RF signal via the RF transceiver, entering a high power-consumption state for engaging in RF communications with an RF signal source; and
upon completion of RF communications or sensor measurements, re-entering the low power-consumption state.

The RFID sensor tag may further comprise clock generation circuitry, configured to generate clocks having at least two different rates corresponding with the medium and high power-consumption states.

According to a further aspect the program instructions cause the RFID sensor tag to implement a method comprising:
upon satisfaction of a predetermined condition, reading at least one sensor value from the one or more sensors; and
storing the sensor value in a memory of the RFID sensor tag, along with information associated with the predetermined condition.

In a further aspect, the program instructions cause the RFID sensor tag to implement a method comprising:
detecting an RF signal at the RF transceiver;
determining whether the detected RF signal comprises an instruction in accordance with a predetermined communications protocol; and
providing a corresponding response only in the event that the detected RF signal comprises an instruction in accordance with the predetermined communications protocol.

In yet a further aspect, the program instructions cause the RFID sensor tag to implement a method comprising:
receiving an RF signal comprising an instruction in accordance with a predetermined communications protocol;
transmitting an RF signal comprising a response indicative of availability of recorded sensor data;
receiving an RF signal comprising an instruction to transmit recorded sensor data, in accordance with the predetermined communications protocol; and
transmitting an RF signal comprising sensor data recorded in the memory.

As will be appreciated, various features of any one of the aspects of the invention discussed above may be applied in relation to other aspects, although this may not be explicitly stated. This, and other features, benefits and advantages of embodiments of the invention will be apparent from the following detailed description, which is provided by way of example only, and should not be taken as limiting of the scope of the invention as set out in the foregoing statements, and as defined in the claims appended hereto.

### BRIEF DESCRIPTION OF THE DRAWINGS

Embodiments of the invention will now be described with reference to the accompanying drawings, in which like reference numerals indicate like features, and wherein:

FIG. 1 is a block diagram of a sensor tag embodying the present invention;

FIG. 2 is a more-detailed block diagram of the sensor tag of FIG. 1;

FIG. 3 is a state transition diagram of a clock controller embodying the invention;

FIG. 4 is a flowchart illustrating spurious activation handling according to an embodiment of the invention;

FIG. 5 is a command/response flow diagram illustrating an activation/interrogation protocol embodying the invention;

FIG. 6 is a flowchart illustrating group activation/interrogation of sensor tags embodying the invention;

FIG. 7 is an exemplary timestamp-temperature data format embodying the invention;

FIG. 8 is a temperature-time graph illustrating a method of further data reduction according to an embodiment of the invention;

FIG. 9 is a block diagram of a reader/writer system embodying the invention;

FIG. 10 is a block diagram illustrating microcontroller firmware components of the reader/writer system of FIG. 9;

FIG. 11 is a flowchart illustrating receiver firmware operation;

FIG. 12 is a flowchart illustrating a method of adjusting interrogation range according to an embodiment of the invention; and

FIG. 13 is a block diagram illustrating major software components of the reader/writer system of FIG. 9.

### DETAILED DESCRIPTION

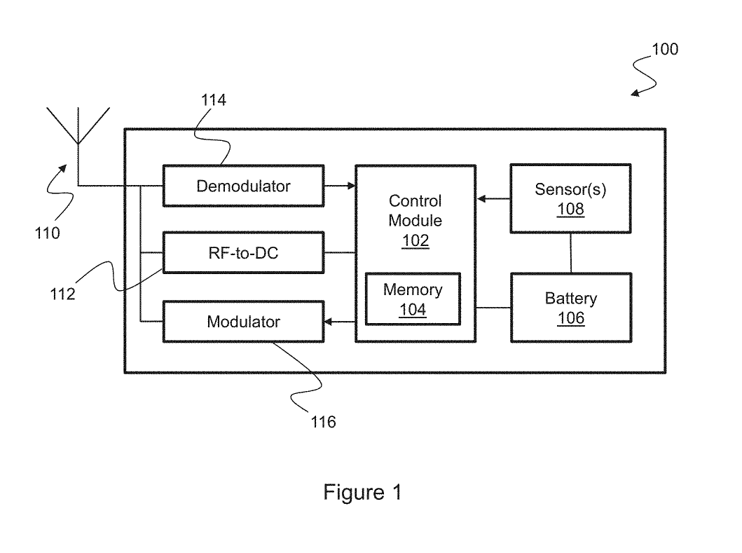

FIG. 1 is a high-level block diagram of a sensor tag 100 according to an embodiment of the invention.

The sensor tag 100 comprises a control module 102, having a memory 104. The memory 104 may comprise non-volatile storage for operating programs and data, and volatile storage for use as scratch space and/or for temporary variables.

The sensor tag 100 further comprises a battery 106, as a basic power source for the control module 102 and other components of the tag 100.

The specific embodiment 100 of the RFID sensor tag shown in FIG. 1 further comprises a temperature sensor 108. Within this specification, the temperature sensor 108 is used as an example of environmental sensing that may be performed by an RFID sensor tag, however it will be appreciated that this is not intended to limit the scope of the invention. For example, other forms of environmental sensor, such as ambient light or humidity sensors, and/or other types of sensing or monitoring devices, such as a Global Positioning System (GPS) receiver, may be additionally, or alternatively, incorporated into an RFID sensor tag embodying the invention.

The sensor tag 100 further comprises an antenna element 110. The antenna element 110 is used to receive and transmit signals within an operating frequency band. In the exemplary embodiments described herein, the operating frequency band is within the 5.725 to 5.850 GHz SHF band. However, alternative RF bands, such as frequencies within the VHF or UHF, bands may be employed.

At present, there is no established or widely-adopted industry standard relating to the operation of RFID tags operating at around 5.8 GHz in the SHF band. However, in the interests of optimising development effort, as well as assisting with general interoperability, industry acceptance, and so forth, embodiments of the invention advantageously adopt features of existing RFID standards in other operating bands to the extent that this is practicable.

An RF-to-DC conversion module 112 is used to extract or ‘harvest’ energy from a received RF signal, which may be used as a power source for the control module 102 and/or other components of the sensor tag 100. Advantageously, employing energy harvested from the received RF signal reduces the load on the battery 106, thereby increasing battery life. The sensor tag 100 further comprises a transceiver comprising an RF demodulator 114 and an RF modulator 116. The RF demodulator component 114 extracts clock and data from a valid received RF signal, and provides these to the control module 102. Data is transmitted by the control module 102 via the RF modulator component 116.

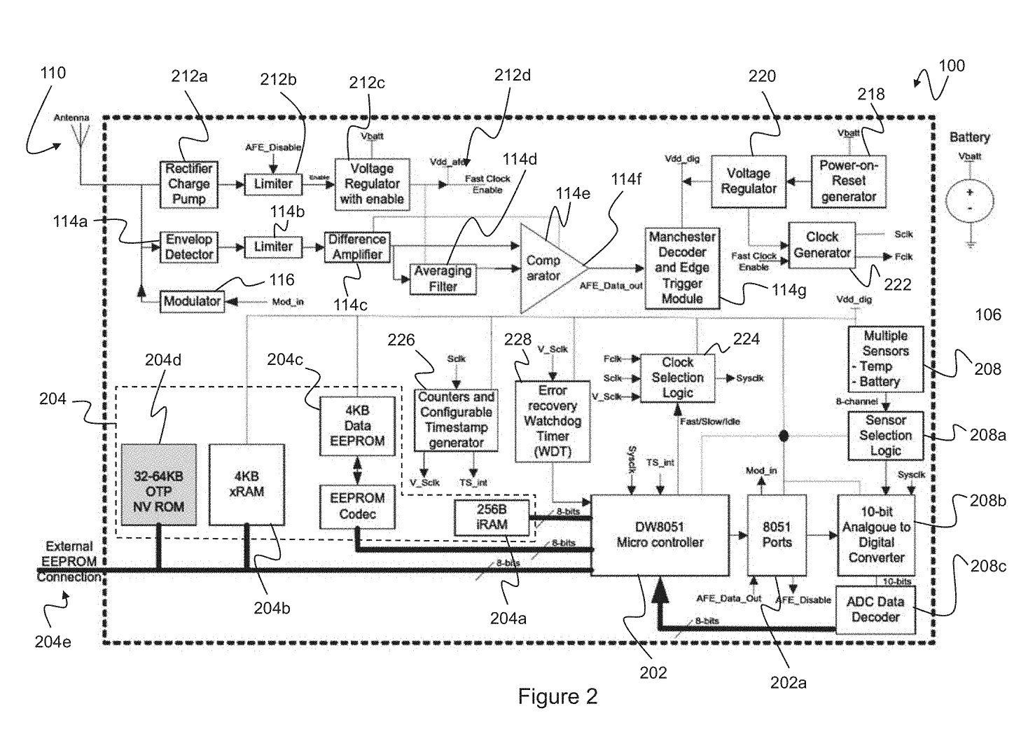

FIG. 2 shows a more-detailed block diagram of the sensor tag 100. In the disclosed embodiment, all of the components illustrated in FIG. 2 are integrated onto a single chip, which may be constructed using predesigned circuit elements (commonly known as IP), which are assembled into a System-on-a-Chip (SoC) design. However, it will be appreciated that in alternative embodiments an RFID sensor tag 100 may be implemented using a number of individual physical components.

The control module 102 of the tag 100 comprises a microcontroller 202. The microcontroller 202 is interfaced with a number of input/output (I/O) ports, such as serial ports 202a. The I/O ports 202a provide the interface between the microcontroller 202 and a number of other components of the tag 100, including the sensors and the RF communications front-end.

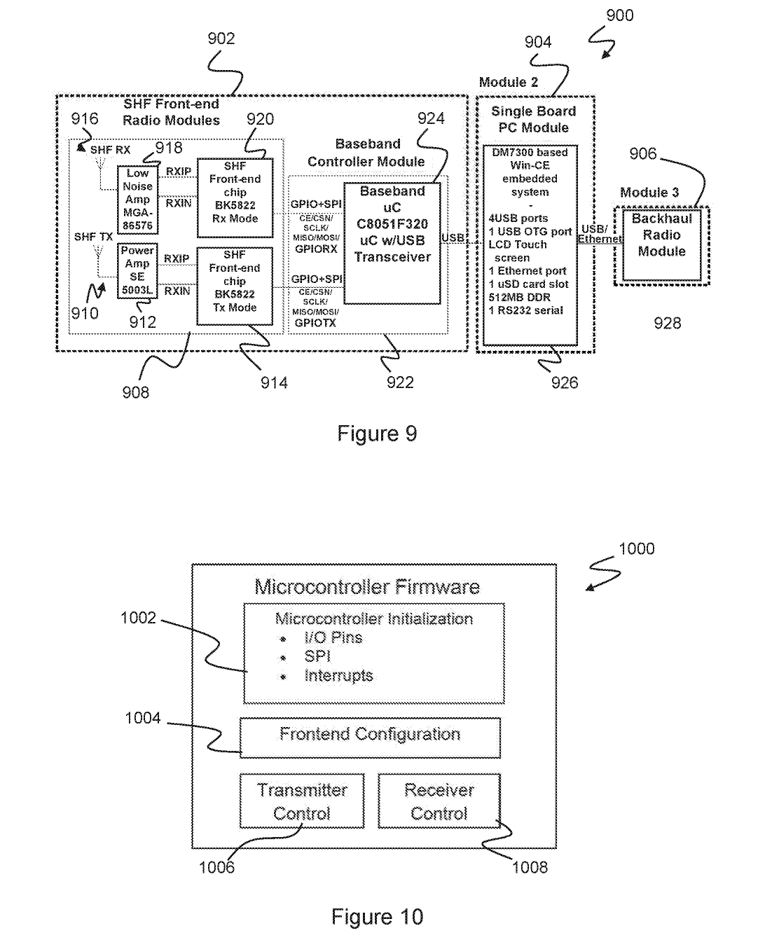

In particular, the I/O ports 202a receive the decoded incoming signal from the demodulator 114, and output the signal for transmission via the modulator 116. In some embodiments, the transmitted signal provided to the modulator 116 is clocked using a configurable-frequency clock so as to introduce a frequency offset between received and backscattered RF signals. In this case, a reader/writer apparatus (such as described below with reference to FIG. 9) may tune a corresponding receiver to the backscattered signal frequency, taking into account the offset, enabling improved detection of weak signals transmitted from the sensor tag 100 in the presence of a stronger transmitted signal. In an exemplary embodiment, an offset of 10 MHz has been found to provide a suitable improvement in sensitivity.

The memory 104 comprises a number of distinct memory components. As shown, there is a small (256 byte) internal Random Access Memory (RAM) 204a, which is used for storage of variables and other scratch data. A larger (4 kB) external RAM 204b is used for temporary storage of larger quantities of data required by the normal operation of the microcontroller 202. A non-volatile memory, in the form of a 4 kB EEPROM 204c, is provided for storage of recorded information, such as sensor data. A non-volatile Read Only Memory (ROM) 204d is provided for storage of fixed programs and data required for operation of the microcontroller 202, and which are used and executed in order to implement the functionality of the sensor tag 100. An optional external data connection 204e may also be provided, which enables interfacing to an external EEPROM, which is used for programming and development of prototype software for the microcontroller 202 prior to finalisation, and permanent storage within the NV ROM 204d. In a final commercial embodiment, the external EEPROM interface 204e is not required, and may be omitted.

The tag 100 also includes sensors 208. These may comprise a temperature sensor (as discussed above with reference to FIG. 1), as well as any other sensors which are required for the applications in which the RFID tag 100 is to be employed. Additionally, the embodiment of the sensor tag 100 shown in FIG. 2 comprises a battery sensor, which is configured to detect a reduction in terminal voltage of the battery 106, enabling the implementation of a low battery indication.

Sensor selection logic 208a enables the microcontroller 202 to select a desired one of the available sensors 208. An analog-to-digital converter (ADC) 208b, and ADC decoder 208c are provided in order to convert sensor signals into a digital representation readable by the microcontroller 202. In the presently-disclosed embodiment, the ADC output is provided as a 10-bit word, which is read by the microcontroller 202 via two 8-bit reads.

The RF-to-DC converter 112 comprises a rectifier charge pump 212a, a limiter 212b, and a voltage regulator 212c. Together, these provide a regulated power supply output 212d, which also acts as an indication of the presence of an RF signal within the operating band of the tag 100. While the power supply 212d derived from the received RF signal may be insufficient, by itself, to power all functions of the sensor tag 100, it nonetheless reduces the power supply requirements of the battery 106, enabling extended battery life.

The RF demodulator 114 comprises an envelope detector 114a, a limiter 114b, a difference amplifier 114c, an averaging filter 114d, and a comparator 114e. Together, these components provide a received data output signal 114f, which is input to a Manchester decoder and edge-trigger module 114g. The Manchester decoder provides synchronised clock and data output bits that are read by the microcontroller via the I/O ports module 202a.

A dedicated hardware based Manchester data decoding is effective for received signals that are not too severely distorted (e.g. the waveform duty cycle). If greater sensitivity or robustness is required, embodiments of the invention may implement additional or alternative clock and data recovery techniques. For example, in one embodiment the output 114f of the comparator 114e is sampled at a rate substantially exceeding the data rate, and the times (i.e. number of samples) between waveform transitions is stored in a first-in/first-out (FIFO) buffer memory, from which they are subsequently retrieved by the microcontroller 202. This additional technique can improve the robustness of the receiver in the presence of substantial timing jitter caused by additive noise and/or other sources of signal distortion.

In the embodiment of the sensor tag 100 shown in FIGS. 1 and 2, the RF-to-DC converter 112 and the demodulator 114 are shown as separate blocks of components. This is a convenient arrangement for the purposes of explaining the functionality of these blocks, and represents one practical embodiment of the sensor tag. In an alternative embodiment these two blocks, both of which operate upon signals received via the antenna 110, are combined into a single demodulation and power recovery block. One characteristic of the combined implementation is a reduced electrical loading on the antenna 110.

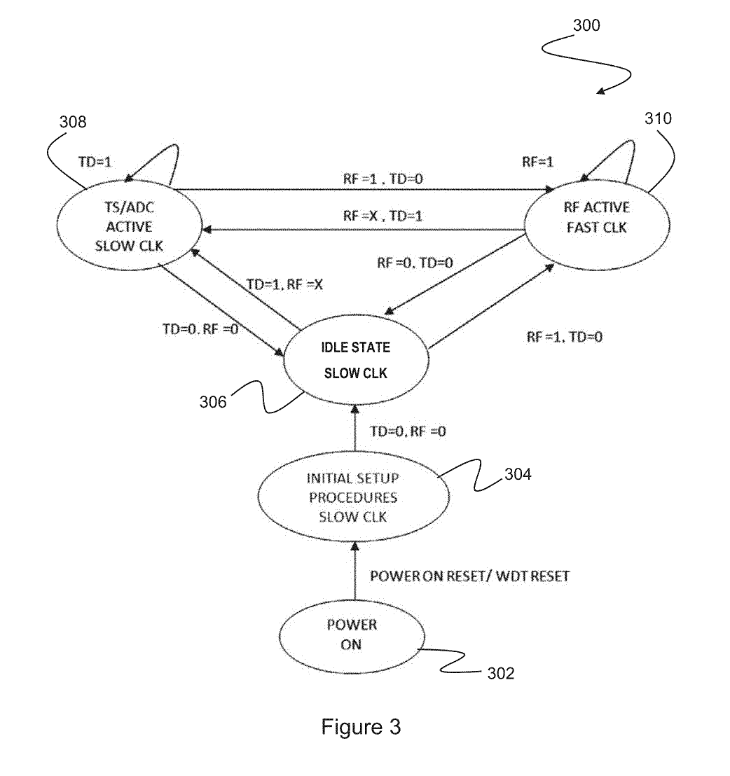

The basic power supply of the sensor tag 100 comprises a power-on-reset generator 218, which is connected to the battery 106. The output is conditioned via a voltage regulator 220, to produce a fixed digital voltage supply source. A clock generator 222 generates either a ‘slow clock’, or a ‘fast clock’, depending upon whether or not an RF field is present, as indicated by the output 212d. The sensor tag 100 also employs a ‘very slow clock’, and selection of a system clock from the three available clocks is performed by clock selection logic 224 under control of a signal from the microcontroller 202. The use of the three clocks is described in greater detail below, with reference to FIG. 3.

The sensor tag 100 further comprises counters and a configurable timestamp generator 226, which are used for various timing and recording functions, as described in greater detail below with reference to a number of the following diagrams.

Finally, the sensor tag 100 comprises an Error Recovery Watchdog Timer (WDT) 228. This timer is operated by the very slow clock, and is reset by the microcontroller 202 at various points during its normal operation under control of the program code stored within the non-volatile memory 204d. Failure by the microcontroller 202 to reset the WDT 228 within the timeout period causes the WDT to reset the microcontroller 202. This prevents any minor or intermittent software or hardware glitch from permanently disabling the sensor tag 100.

FIG. 3 is a state transition diagram 300 exemplifying clock control according to an embodiment of the invention. As noted above, the disclosed RFID sensor tag 100 uses three clocks. A ‘slow clock’, for example operating at 1 MHz, is used for normal processing functions of the microcontroller 202, not involving RF signalling. A ‘very slow clock’, for example of 3.8 Hz, provides a low-power ‘idle’ or ‘sleep’ state, in which the tag 100 performs no substantive processing. A ‘fast clock’, for example at 22 MHz, is required when processing high-speed RF signals.

The state transition diagram 300 illustrates the logic used for switching between the ‘fast’ and ‘slow’ clocks. The controller is initially in state 302, at power-on, or other reset. Initial setup and configuration procedures are executed at the slow clock rate, in state 304. Once these procedures are completed, the sensor tag 100 may enter an idle state 306, in which the slow clock remains supplied to the microcontroller. However, the microcontroller enters a low power consumption ‘sleep’ mode, in which no processing is performed until such time as it is awoken by an interrupt signal.

Generally, one of two events will wake the sensor tag 100 from the idle state 306. One such event is the requirement to collect and record a sensor reading. A signal triggering a sensor reading may be generated by one of the counters within the block 226. Upon receipt of this signal, for example via an interrupt input to the microcontroller 202, the system moves into a sensor-active state 308, operating at the slow clock rate. In this state, the microcontroller 202 receives a sensor measurement, and makes any appropriate recordings within the non-volatile memory 204c. Once the sensor recording is complete, the tag 100 will typically return to the idle state 306.

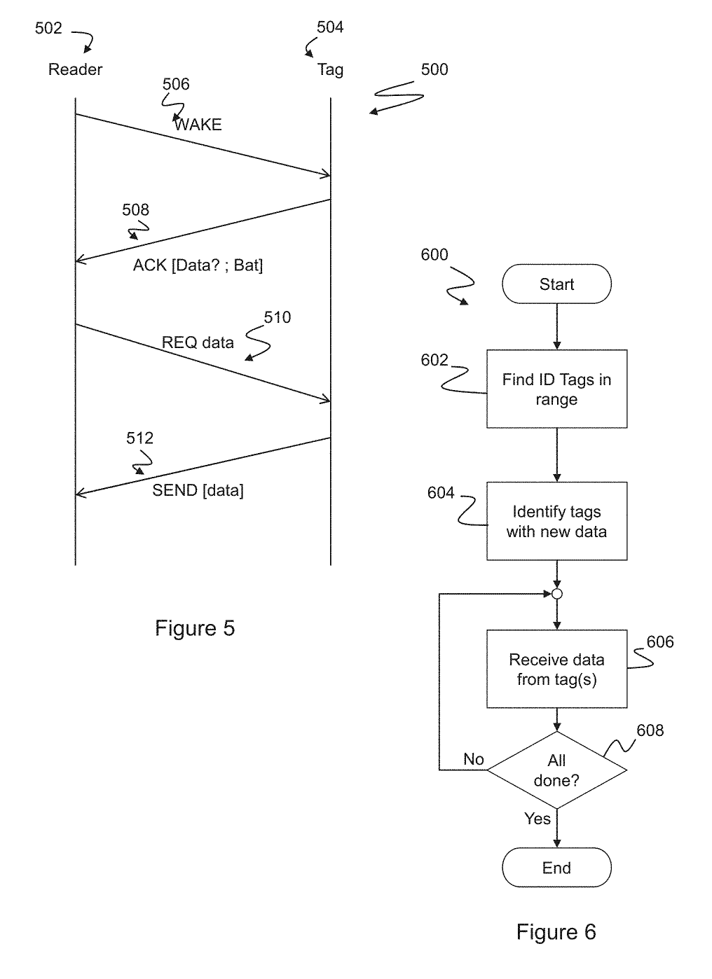

The second event which may cause the tag 100 to exit to the idle state 306 is the detection of an RF signal. The presence of a suitable RF signal causes a supply voltage to be present at the output 212d. This also activates the fast clock, and causes the sensor tag 100 to enter the RF active state 310. In this state, the microcontroller receives and/or transmits RF data signals, according to protocols defined for communications with an RF tag reader. Some of these functions are described in greater detail below, for example with reference to FIG. 5.

Once the RF signal is no longer present, the sensor tag 100 will generally return to the idle state 306.

In some circumstances the tag 100 may also transition between the sensor-active state 308 and the RF-active state 310. This will occur, for example, if an RF signal is present upon completion of sensor data recording, which was not present at the commencement of the recording. Similarly, the tag 100 may transition from the RF-active state 310 to the sensor-active state 308 if a sensor recording signal is present following completion of RF processing.

The ‘very slow clock’ is used for time-stamp generation, running the watchdog timer, and may be employed for other non-time-critical functions of the tag 100. It is therefore instrumental in ensuring that the microcontroller 202 is woken from the ‘sleep’ mode in the idle state 306, although the very slow clock is never actually supplied to the controller 202.

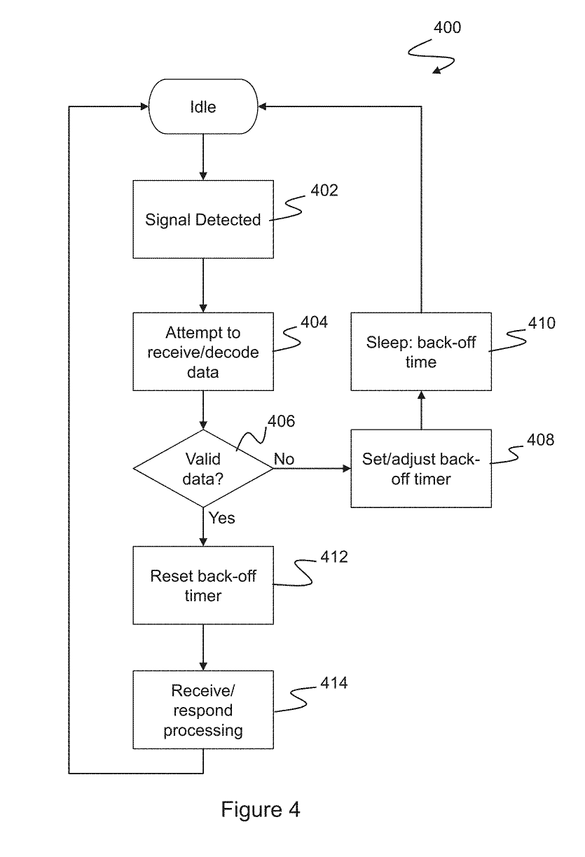

Turning now to FIG. 4, there is shown a flowchart 400 illustrating spurious activation handling according to an embodiment of the invention. The purpose of the procedure illustrated in FIG. 4 is to ensure that the tag does not remain in the RF-active state 310 in the event that it is activated by a spurious RF signal within the operating frequency band. This may occur, for example, due to interference received from other devices operating within the same band. As will be appreciated, operation in the fast-clock mode consumes considerably more power than operation within the slow-clock or very-slow-clock modes. Unnecessary operation within the fast-clock mode is therefore preferably avoided.

As shown in the flowchart 400, from the initial idle state an RF signal is first detected at step 402. The tag 100 moves into the RF-active state 310. In this state, it attempts 404 to receive and decode data transmitted on the detected RF carrier. If valid data is detected 406, then the tag 100 will proceed with normal processing of this received information.

However, if no valid data is detected the microcontroller 202 may instead at least partially disable the RF transceiver (receiver and/or transmitter). In the embodiment 100 illustrated in FIG. 2 this is done by applying a disable signal to the limiter 212b. This prevents a sufficient signal from being input to the voltage regulator 212c, deactivating the RF signal output 212d. In the present embodiment 100, components of the RF front-end, including modulator 116 and demodulator 114, are disabled by disabling the voltage regulator output going to these circuit blocks. According to this implementation, only the RF-to-DC converter circuit 112 remains functional to detect the RF signal and generate a trigger signal to re-enable the disabled components when sufficient RF activity is detected

A timer is used to control the duration for which the RF detection is disabled. Accordingly, at step 408 this timer is set, or adjusted, which causes a minimum corresponding time delay 410 before the tag 100 can once again be woken from the idle state.

As noted above, the timer may be either set or adjusted at step 408. Adjustment is desirable, for example, in order to implement a ‘back-off’ strategy to prevent repeated spurious awakening. For example, the tag 100 may be located within an area of continuous interference, and it is undesirable that it be reawakened too frequently in these circumstances, since until the environmental conditions change these awakenings will again be spurious. However, it is also undesirable to use a long time-out delay in the event that the spurious activation was caused by a short-term RF spike. Accordingly, a compromise strategy is to use a relatively short delay initially, but to increase this delay upon repeated spurious activation. Accordingly, upon each spurious activation the value of the back-off timer may be increased at step 408, at least until some maximum value is reached.

While a timer, as described above, provides one practical back-off mechanism, alternative techniques may be employed, such as will be apparent to persons skilled in the art. For example, a count of successive spurious activations may be maintained, and the tag 100 may ‘lock’ execution of selected commands after a predetermined counter value is reached.

In the event that the activation is not spurious, i.e. valid data is detected, the back-off timer is reset at step 412, so that any subsequent spurious activation will once again be followed by a relatively short delay.

At step 414, the microcontroller 202 performs the required RF receive and response processing, in accordance with the received interrogation signal, before returning again to the idle state.

In performing the RF processing, it is also desirable to minimise the amount of data transmitted, in order to minimise the time spent in the RF-active state 310, and thus limit the drain on the battery 106. FIG. 5 is a schematic diagram 500 illustrating an activation/interrogation protocol embodying the present invention, which is designed to reduce power consumption during interrogation.

As shown in the schematic diagram 500, a reader 502 communicates with a tag 504. Initially, the reader sends an interrogation RF signal 506 which awakens the tag. The signal 506 carries intelligible data which can be decoded by the tag in order to verify the validity of the interrogation signal, i.e. to distinguish it from a spurious activation. The initial interrogation signal 506 may also carry identification data of one or more RFID sensor tags, indicating that only those tags matching the sensor data should respond. In the exemplary embodiment, this communication between the reader 502 and the tag 504 is conducted in accordance with an air interface protocol for communications between a tag and a reader/writer adapted from the specification ISO/IEC 18000-4 2.45 GHz air interface protocol standard. System protocols are implemented in Mode 1: protocol parameters, and Mode 1: anti-collision parameters, to enable the reader/writer to identify and communicate with multiple tags (up to a maximum of 120 tags) in a single read cycle. The exemplary system also adapts the specification ISO/IEC 18000-4 Mode 1: physical and media access control (MAC) parameters for forward link and back-scatter return link, subject to modifications required to translate from the 2.45 GHz frequency band to the 5.8 GHz SHF band.

Data integrity protection mechanisms are also adapted from the ISO/IEC 18000-4 Mode 1 protocol. Further details of these techniques are available in the relevant specifications and further discussion is therefore not required herein. The key point is that the communications depicted in the schematic diagram 500 of FIG. 5 are all appropriately supported and verified in accordance with a set of established protocols. Furthermore, it will be appreciated that it is not essential that the ISO/IEC 18000-4 protocols be employed, and other protocols may be utilised within the scope of the invention.

Upon verification of a valid interrogation signal, the tag transmits back an acknowledgment 508, which includes one or more status indications. A first status indication comprises a ‘new data’ or ‘data status’ indication. Only if the tag has any recorded data of interest, which has not previously been retrieved, will this indication be set. This enables further communication to be concluded immediately, and allows the tag to return to the idle state 306, without any further unnecessary RF communications taking place.

Additionally, the status indications in the acknowledgment transmission 508 may include a battery indication, which is active if the battery sensor has detected a low-battery condition. This enables the reader to flag to an operator that the particular sensor tag returning this indication is nearing the end-of-life, and/or requires a battery replacement.

In the event that new data is available, the reader 502 transmits a request 510 for the data to the tag 504. In response, the tag 504 sends 512 the previously unread data back to the reader 502.

The example 500 illustrated in FIG. 5 represents an extended communications interaction between the reader 502 and the tag 504. It will be appreciated, however, that an RFID sensor tag embodying the invention may be configured to implement and/or respond to a range of different instructions transmitted by a reader. In some cases, a single ‘command/response’ (e.g. 506, 508) sequence will be sufficient to complete an operation. In other cases, further transaction may be required in order to complete operations and/or transfer of data. The two-step transaction 500 should therefore be understood to be exemplary only.

As mentioned above, the ISO/IEC air interface protocol standards enable identification and communications with multiple tags within the reader range. Again, however, it is desirable that such group communications are conducted while minimising the power requirements of the sensor tags.

FIG. 6 is a flowchart illustrating a group activation/interrogation of sensor tags which is designed to achieve this desired result. According to the process 600 illustrated in the flowchart, the reader identifies the sensor tags in range at step 602, and determines, from the returned status indicators, which tags have new data to be retrieved, at step 604. At this point, all tags with no new data for retrieval may return to the idle state 306, in order to conserve battery reserves.

The reader/writer then interrogates those tags which indicated the presence of new data, at step 606. This interrogation proceeds 608 until the new data has been retrieved from all responding tags.

In addition to the power-saving feature described above, with reference to FIGS. 3 to 6, a further feature of embodiments of the present invention is the implementation of measures to reduce the quantity of data recording and storage, enabling a reduction in the size of EEPROM 204c required for sensor data, as well as a reduction in the amount of data required to be transmitted in response to RF interrogation.

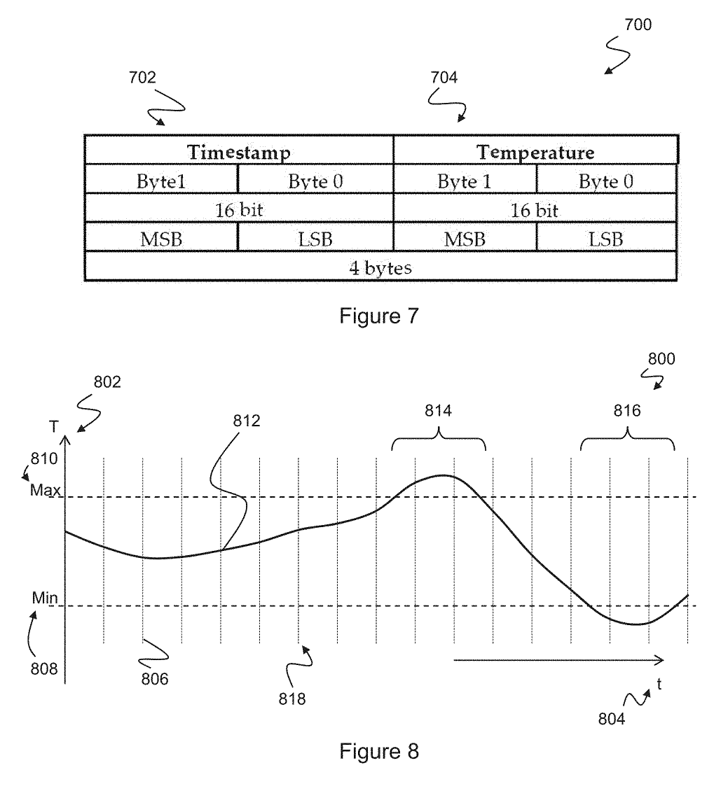

In this regard, FIG. 7 illustrates an exemplary timestamp-temperature data format 700 according to embodiments of the invention. According to the format 700, each sensor reading is stored as a pair of 16-bit words, in which the first word 702 is a two-byte timestamp value, and the second word 704 is a two-byte temperature value. While the format 700 provides one possible example of a suitable data structure, it will be appreciated that in general the data format, size and content depend on requirements and/or configuration of the target application of the tag.

In order to enable a reasonable recording period using a two-byte timestamp value 702, the sensor tag may initially be programmed with a reference timestamp, i.e. a value representing an absolute starting time to which the timestamp 702 represents a future offset. The timestamp value may itself simply be the value of a counter which is maintained within the counters and configurable timestamp generator 226 of the sensor tag 100. The rate at which the timestamp counter increments may depend upon the desired maximum operating period of the sensor tag 100. For example, if the counter increments once every 10 minutes, the maximum operating period before counter overflow is approximately 7.6 days. If temperature data is recorded at this same rate, i.e. six records per hour, or 144 records per day, the maximum number of recorded timestamp-temperature data pairs will be 1092. This would require 4368 bytes of storage, which is slightly in excess of the 4 kB provided in the EEPROM 204c. Accordingly, the exemplary sensor tag 100 would be storage-limited in this example to a maximum of 1024 temperature readings, equivalent to just over 7.1 days operation.

In order to enable longer-term data recording, and/or recording with higher temporal resolution, in some embodiments the invention may employ more-efficient data recording logic. One example is illustrated by the temperature/time graph 800 shown in FIG. 8. The graph 800 shows recorded temperature 802 on the vertical axis, and elapsed time 804 on the horizontal axis. Each of the vertical lines 806 represents one data-recording interval, i.e. a time-instant at which a temperature reading is taken. In some applications, such as perishable goods storage or transport, the actual temperature is not important so long as it falls within a predetermined safe range. In the graph 800 a safe range is represented by the horizontal lines indicating minimum temperature 808 and maximum temperature 810. For example, a product such as milk is generally guaranteed to keep until at least its specified use-by date, so long as it is stored constantly below a temperature of four degrees Celsius. Additionally, it is desirable for quality reasons that milk not be allowed to freeze, i.e. that the temperature does not fall below zero degrees Celsius. The temperature is therefore unimportant in this case so long as it is above a minimum temperature 808 of zero degrees, and below maximum temperature 810 of four degrees.

The curve 812 in the graph 800 represents an exemplary trace of temperature as a function of time, with temperature readings being taken at each marked time interval. The temperature stays between the minimum 808 and maximum 810 values at all times shown, except for the period 814 during which the temperature is above the maximum 810, and the period 816, during which the temperature is below the minimum 808. If only the readings taken during these two periods are recorded, a significant reduction in stored data is achieved, and yet all of the salient information is retained, i.e. the times and temperature readings during which the sensor tag detected ambient temperatures beyond the limits of the safe range.

Additionally, the microcontroller 202 may be programmed to record temperature readings at fixed intervals, even if the temperature is between the predetermined safe range. For example, recordings may be made, for verification purposes, once per hour, regardless of temperature reading. In this case, for example, a recording would be made at the time interval 818, even though the temperature at that time falls between the minimum 808 and maximum 810 levels.

As will be appreciated, other data storage strategies may be employed in a particular application, in order to minimise storage requirements by recording only information that is of interest and/or importance.

Turning now to FIG. 9, there is shown a block diagram of an exemplary reader/writer apparatus suitable for communication with the sensor tag 100 embodying the invention. The reader/writer apparatus 900 comprises three modules: a SHF RF front-end 902; a microprocessor module 904; and a backhaul communications module 906.

The SHF RF front-end 902 comprises an analog part 908 comprising the radio modules. A transmit antenna 910 is driven by a power amplifier 912, which in turn is driven by a commercially-available SHF front-end chip 914, operating in its transmit mode. On the receiving side, a receiving antenna 916 drives a commercially available low-noise amplifier 918, which in turn passes signals to a commercially-available SHF front-end chip 920, operating in its receive mode. In some embodiments, the transmit and receive frequencies may be the same. In other embodiments, in which the sensor tag 100 is configured to introduce an offset between its received and backscattered signal, the receiving side of the RF front-end 902 is detuned from the transmitter by the configured frequency offset. As noted above, in an exemplary embodiment an offset frequency of 10 MHz has been found to be effective, however, as will be appreciated by persons skilled in the art, a range of offset frequencies would be suitable.

The SHF RF front-end module 902 further comprises a baseband controller 922, which principally comprises a commercially available baseband microcontroller which is interfaced to the transmitting and receiving front-end chips 914, 920 and which provides a standard Universal Serial Bus (USB) interface to the microprocessor module 904.

The microprocessor module 904 of the exemplary embodiment is a single-board, Windows-compatible, embedded microprocessor system 926. The single-board computer 926 includes a number of standard I/O ports, including USB ports, an ethernet port, and an RS232 serial port. Furthermore, the single-board computer 926 comprises an LCD touchscreen for interfacing with a human operator. A backhaul network module 906 is connected to the single-board computer 926 via one of the standard interface ports, for example via a USB port or by the ethernet port.

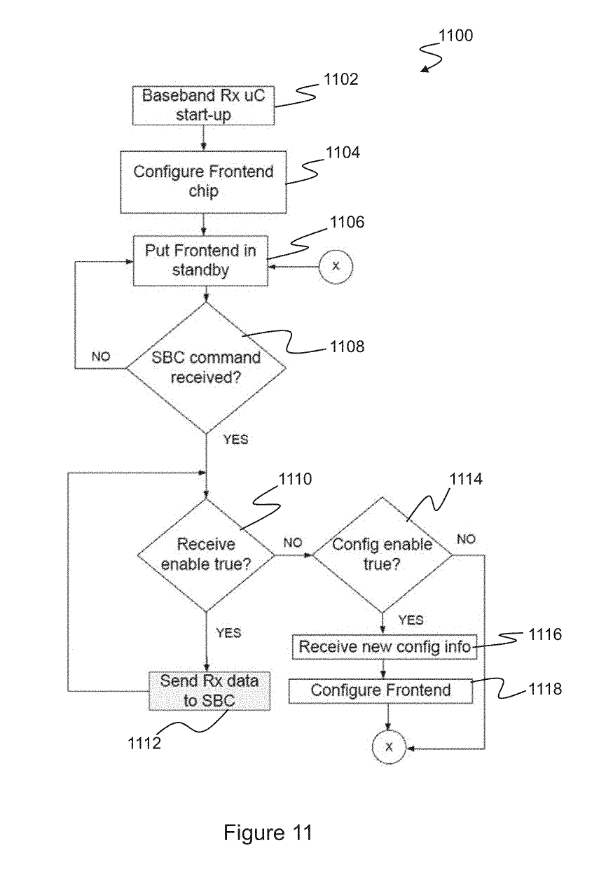

In the exemplary embodiment 900 the network communications module 906 is a backhaul radio module 928, e.g. a network interface operating in accordance with a GSM, 3G, LTE/4G. WiMAX, Wi-Fi. or other suitable protocols. In other embodiments, the backhaul communications module 906 may operate via wired connections to a wide area network (WAN), such as the Internet. In either case, data collected from sensor tags by the reader/writer apparatus 900 may be transmitted back to a central data collection point, and/or remotely accessed, via the backhaul communications connection. FIGS. 10 and 11 illustrate some aspects of the programming and operation of the baseband microcontroller 924. In particular, FIG. 10 is a block diagram 1000 illustrating microcontroller firmware components, while FIG. 11 is a flowchart 1100 illustrating a general process of receiver firmware operation.

Turning firstly to FIG. 10, the microcontroller firmware 1000 comprises a number of main components. A first component 1002 is responsible for general initialisation of the microcontroller, including set up of I/O PINS, the enhanced serial peripheral interface (SPI) communications channels with the SHF front-end chips 910, 914, interrupt configuration, and so forth. A second module 1004 is responsible for front-end configuration, which may be required at start-up, and also if a reconfiguration is required under control of the single-board computer 926. Third and fourth firmware modules are for transmitter control 1006 and receiver control 1008, according to the operational requirements of the SHF front-end chips 914, 920.

The flowchart 1100 in FIG. 11 illustrates initialisation, configuration and receiver firmware operation. In a first step 1102 the baseband microcontroller 924 is initialised, and executes the code within the initialisation component 1002. At step 1104 the front-end configuration is performed, i.e. component 1004 is executed.

At step 1106 the front-end receiver chip is placed in standby mode. It remains in this state until an appropriate command is received from the single-board computer, according to the decision step 1108. The command may comprise instructions to enable receiving, in which case the decision 1110 branches to step 1112, in which the SHF front-end 902 operates to receive data from one or more RFID sensor tags, and to transfer this data to the single-board computer 926.

Alternatively, the command received from the single-board computer 926 may comprise reconfiguration instructions, in which case the decision step 1114 directs control to step 1116, at which new configuration information is received from the single-board computer 926. This information is used, by the front-end configuration component 1004, to reconfigure the SHF front-end at step 1118. The front-end then is returned to standby mode 1106.

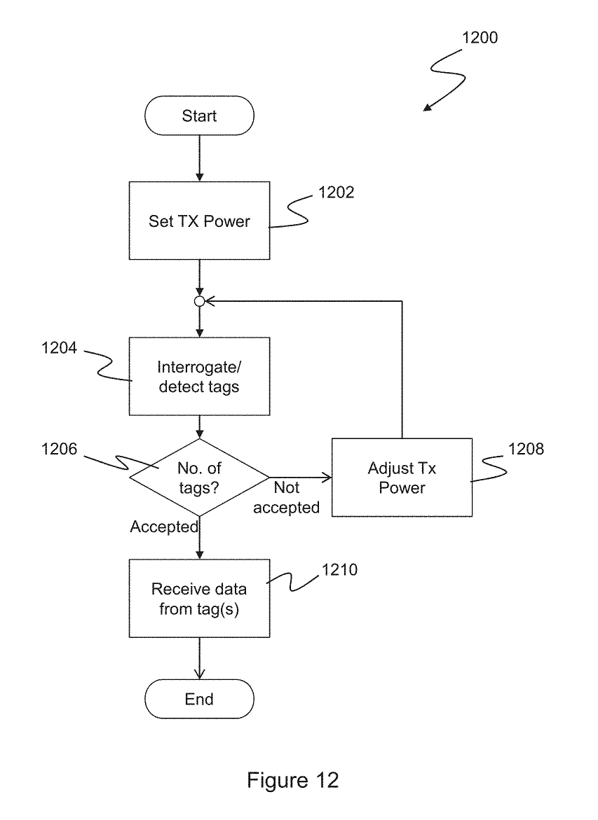

A further feature of some embodiments of the invention, which may be implemented through reconfiguration of the SHF front-end, relates to the interrogation of multiple tags. In particular, it may be desirable in some applications to increase or decrease the range of operation of the reader/writer apparatus 900, in order to communicate with a greater or lesser number of RFID sensor tags. This may be achieved by increasing or decreasing the transmit power from the SHF front-end, to control the range over which the RF signal may be received. The flowchart 1200 in FIG. 12 illustrates a method of adjusting the interrogation range according to some embodiments of the invention.

At step 1202, the SHF front-end is configured to set an initial transmit power for interrogation of RFID sensor tags within range. At step 1204 a group interrogation is initiated, to which all tags within range will respond. At step 1206 a decision is made as to whether the number of tags detected is acceptable or not acceptable. In the case of a handheld reading apparatus, for example, this decision may involve user input, whereby an operator may be in a position to assess whether the current range of the reader is too great or too small, based upon the number of tags detected. For example, in a warehouse environment there may be a number of containers present, all of which contain a number of RFID sensor tags, and an operator may be able to assess whether the reader is within range of only a single container, or multiple containers.

If the range is not acceptable (i.e. too great or too small) the SHF front-end is reconfigured in order to adjust the interrogation transmit power, at step 1208. The steps of interrogation 1204 and decision 1206 may then be repeated, and subsequently further repeated if necessary.

Once the range has been adjusted to the desired level, the reader may then be used to receive data from all of the RFID sensor tags within range, at step 1210.

In some embodiments, a ‘sleep’ function may alternatively, or additionally, be employed during a multiple tag interrogation procedure, whereby a tag will enter a non-responsive, low power-consumption, state for a period of time once it has responded to interrogation by the reader. This enables, for example, interrogation of tags by multiple operations covering overlapping regions. Since each tag will only respond once, the reader does not need to handle duplicate responses. Furthermore, since each tag responds only once to interrogation, power consumption is minimised. The tags may automatically enter the low power state after providing a response, or they may do so in response to a separate ‘sleep’ command transmitted by the reader.

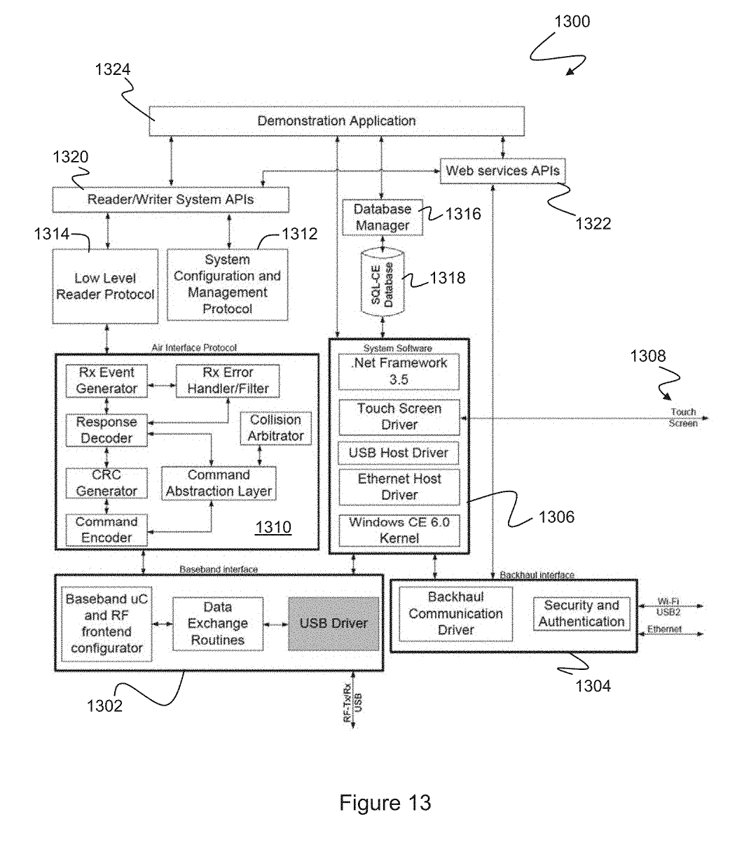

Turning now to FIG. 13, there is shown a block diagram 1300 illustrating major software components of the reader/writer system 900 shown in FIG. 9.

Starting at the lowest level, the software system 1300 comprises a baseband interface driver component 1302, which is responsible for configuration and operation of the SHF front-end module 902.

Additionally, a backhaul interface driver module 1304 is responsible for configuration and communications via the backhaul communications module 906. This includes communications drivers, as well as a security and authentication component which is desirable since the reader/writer apparatus is advantageously accessible remotely, e.g. via the Internet.

The baseband and backhaul interface drivers 1302, 1304 interface with the operating system software 1306, which comprises a Windows CE kernel, various standard device drivers, a touchscreen driver, for communications with the user via the touchscreen interface 1308, and the .Net framework providing access to operating system functions by user applications.

A further software component is the air interface protocol component 1310. This is responsible for layer two and three processing of the RFID communications protocols, e.g. as specified in the ISO/IEC 18000-4 specifications. The functions of the air interface protocol component 1310 include implementation of data integrity protection mechanisms (e.g. CRC generation/checking), encoding and decoding of commands and responses, arbitration of collisions/contention, error handling, and event generation.

Further software components provide access for system configuration and management (1312) of the reader/writer apparatus, as well as a low-level reader protocol 1314, which is built on the facilities provided by the air interface protocol component 1310.

The software system 1300 further comprises a database manager component 1316, which provides access to an SQL-CE database 1318.

Application programming interfaces (APIs) are provided for application access to facilities of the reader/writer system 1320, as well as to web services 1322, which may be delivered to remote clients via the backhaul interface 1304.

All of the above-described components ultimately provide interfaces and facilities for use by a user application 1324, via which the reader/writer apparatus may be operated, and data retrieved from interrogated RFID sensor tags may be reviewed and stored within the database 1318 for future reference.

Overall, embodiments of the invention provide a multi-function RFID sensor tag system which facilitates continuous monitoring of environmental and other parameters over an extended period of time, whether or not the tag is within range of a compatible RFID reader. Features and facilities are provided for reduction of power consumption, and extension of battery life. Furthermore, various embodiments of the invention provide for efficient storage of sensor data and associated timestamp information.

The embodiments described above are presented by way of example only, and are not intended to be exhaustive of all features and facilities which may be implemented or provided in accordance with the invention. For example, additional sensing components may be included, such as GPS receivers, light sensors, humidity sensors, and so forth. The specific embodiment of the RFID sensor tag 100, which is described herein, is able to support up to eight sensors, however this also is not intended as a limiting feature of the invention, and any number of sensors as may be practical in a given application may be provided.

It should therefore be appreciated that various alternatives and/or modifications of the embodiments described herein will be apparent to persons skilled in the relevant arts of electronic and RF design, and such variants may fall within the scope of the invention, which is as defined by the claims appended hereto.

1-19. (canceled)

20. A method of communicating with one or more RFID sensor tags within a predetermined area, the method comprising:
providing an RFID sensor tag interrogation apparatus comprising an RF transceiver configured to enable control of a transmitted RF power level;
setting the transmitted RF power level to provide an RF signal detectable by RFID sensor tags located within a corresponding region of the predetermined area;
transmitting, by the RFID sensor tag interrogation apparatus, an RFID sensor tag interrogation signal; and
receiving, by the RFID sensor tag interrogation apparatus, one or more responses transmitted by the RFID sensor tags located within the predetermined area.

21. The method of claim 20 which further comprises adjusting the transmitted RF power level to increase or decrease the size of the corresponding region of the predetermined area, based upon responses received from RFID sensor tags located within the region.

22. The method of claim 20 wherein the RFID sensor tags located within the predetermined area are configured to ignore further sensor tag interrogation signals, for at least a predetermined period, once a response has been transmitted to the RFID sensor tag interrogation apparatus.

23. The method of claim 21 wherein the RFID sensor tags located within the predetermined area are configured to ignore further sensor tag interrogation signals, for at least a predetermined period, once a response has been transmitted to the RFID sensor tag interrogation apparatus.
